(19) United States
(12) Patent Application Publication
(10) Pub. No.: US 2018/0184144 A1
(43) Pub. Date: Jun. 28, 2018

(54) APPARATUS AND METHOD FOR ASSET-BASED VIDEO ACCESS

(71) Applicant: March Networks Corporation, Ottawa (CA)

(72) Inventors: Jeffery Ronald CORRALL, Gatineau (CA); Chad Leon VEINOTTE, Ottawa (CA); Rachelle Nadine VERGE, Stittsville (CA)

(21) Appl. No.: 15/388,853

(22) Filed: Dec. 22, 2016

(51) Int. Cl. H04N 21/258; H04N 21/232; H04N 21/2743; G07C 9/00

(52) U.S. Cl. CPC H04N 21/25875; H04N 21/232; G08B 13/19665; G07C 9/00111; H04N 21/2743

(57) ABSTRACT

A method and apparatus are provided for obtaining video associated with a loss-prevention event of interest. Video footage is accessed from a video server based on an asset-based event-of-interest identifier (AEII), or a unique identifier for an RFID-tagged asset. The AEII is created in response to: the RFID-tagged asset being detected by an access point, such as exiting the premises; the RFID-tagged asset belonging to an inventory associated with the premises; and in response to the RFID-tagged asset lacking an asset-associated entry in an authorization database associated with the premises, for example having no record in a point-of-sale (POS) transaction database associated with the asset. The AEII is optionally created when the RFID-tagged asset has a minimum value. Using RFID in a different way than it was intended, RFID detection is integrated with video surveillance data, authorization data, and inventory data to provide advantages compared to existing loss prevention approaches.

### FIELD

The present disclosure relates to video surveillance, including but not limited to accessing stored video associated with an asset of interest.

### BACKGROUND

Video surveillance systems are used to keep watch over physical areas to assist in identifying events of interest. Such events, and associated data, can relate to maintaining safety and security, mitigating risk, increasing operational efficiency, preventing loss of products or revenue, gathering business intelligence, and a variety of other applications.

Loss prevention is particularly important in the retail and banking industries, and extends beyond a simple security check at an exit. In retail, video surveillance can reduce shrink and improve operations and profitability. In banking, video surveillance can cut losses from theft and fraud, speed investigations and improve branch performance.

Often, stored video from a video surveillance system is accessed manually based on parameters of interest with respect to either loss prevention in general, or with respect to a specific incident.

Improvements in approaches for accessing video for the purposes of loss prevention are desirable.

### BRIEF DESCRIPTION OF THE DRAWINGS

Embodiments of the present disclosure will now be described, by way of example only, with reference to the attached Figures.

FIG. 1 is a flowchart illustrating a method according to an embodiment of the present disclosure.

FIG. 2 illustrates a system according to an embodiment of the present disclosure.

FIG. 3 illustrates a screenshot of a report produced by a video management device according to an example embodiment of the present disclosure.

FIG. 4 is a flowchart illustrating a method according to an example embodiment of the present disclosure.

### DETAILED DESCRIPTION

A method and apparatus are provided for obtaining video associated with a loss-prevention event of interest. Video footage is accessed from a video server based on an asset-based event-of-interest identifier (AEII), or a unique identifier for an RFID-tagged asset, or both. The AEII is created in response to: the RFID-tagged asset being detected by an access point, such as exiting the premises; the RFID-tagged asset belonging to an inventory associated with the premises; and in response to the RFID-tagged asset lacking an asset-associated entry in an authorization database associated with the premises, for example having no record in a point-of-sale (POS) transaction database associated with the asset. The AEII is optionally created when the RFID-tagged asset has a minimum value. Using RFID in a different way than it was intended, RFID detection is integrated with video surveillance data, authorization data, and inventory data to provide advantages compared to existing loss prevention approaches.

In an aspect, the present disclosure provides a method of obtaining video associated with a loss prevention event-of-interest, comprising: creating an asset-based event-of-interest identifier associated with an RFID-tagged asset associated with a premises in response to receipt of an indication that: the RFID-tagged asset is detected by an access point; the RFID-tagged asset belongs to inventory associated with the premises; and the RFID-tagged asset lacks an asset-associated entry in an authorization database associated with the premises. The method further comprises accessing video footage from a video server based on the asset-based event-of-interest identifier, or based on the unique identifier for the RFID-tagged asset, or both.

In an example embodiment, the accessing occurs after the event-of-interest has occurred, and wherein the video footage comprises stored video footage accessed from a video archive or other video storage.

In an example embodiment, accessing the video footage comprises accessing live video footage from a video server.

In an example embodiment, detection by the access point comprises detecting that the RFID-tagged item is exiting the premises.

In an example embodiment, detection by the access point comprises detecting that the RFID-tagged item is crossing a threshold.

In an example embodiment, detection by the access point comprises detecting that the RFID-tagged item is leaving a field of view of a camera associated with the premises. In an example embodiment, the authorization database comprises a point-of-sale (POS) transaction database.

In an example embodiment, the RFID-tagged asset comprises an RFID-tagged item for sale.

In an example embodiment, creating the AEII is performed in response to receipt of indications i), ii), and iii), and also in response to an indication that: iv) the RFID-tagged asset has a value that exceeds a stored threshold value.

In an example embodiment, the method further comprises: comparing a value of the RFID-tagged asset with a stored threshold value; and performing step a) only when the value of the RFID-tagged asset exceeds the stored threshold value.

In an example embodiment, creating the asset-based event-of-interest identifier comprises accessing data from a transaction report to determine when the RFID-tagged asset is detected by the access point. In an example embodiment, the data from the transaction report identifies a timeframe associated with the detection by the access point.

In an example embodiment, the method further comprises identifying unauthorized movement of the RFID-tagged asset based on the asset-based event-of-interest identifier and on the video footage accessed from the video server.

In an example embodiment, the method further comprises identifying a dwell time for the RFID-tagged asset based on the asset-based event-of-interest identifier and on the video footage accessed from the video server.

In an example embodiment, the unique identifier for the RFID-tagged asset comprises an electronic product code (EPC), and the video footage is accessed from the video server based on the EPC.

In another aspect, the present disclosure provides a non-transitory machine readable medium having stored thereon statements and instructions for execution by a processor to perform a method as both generally and specifically described and illustrated herein.

In a further aspect, the present disclosure provides a system comprising: a processor; and a memory storing statements and instructions for execution by the processor to perform a method of obtaining video associated with a loss prevention event-of-interest, the method comprising: creating an asset-based event-of-interest identifier associated with an RFID-tagged asset associated with a premises in response to receipt of an indication that: the RFID-tagged asset is detected by an access point; the RFID-tagged asset belongs to inventory associated with the premises; and the RFID-tagged asset lacks an asset-associated entry in an authorization database associated with the premises. The method further comprises accessing video footage from a video server based on the asset-based event-of-interest identifier, or based on the unique identifier for the RFID-tagged asset, or both.

In another aspect, the present disclosure provides a video management device for use in a video surveillance loss prevention system. The video management device comprises: an access point interface configured to enable communication between the video management device and an access point; an inventory interface configured to enable communication between the video management device and an inventory database; an authorization interface configured to enable communication between the video management device and an authorization database; a video interface configured to enable communication between the video management device and a video server; a processor; and a memory. The memory stores statements and instructions for execution by the processor to: create an asset-based event-of-interest identifier (AEII) associated with an RFID-tagged asset associated with a premises in response to receipt of an indication that: i) the RFID-tagged asset is detected by the access point; ii) the RFID-tagged asset belongs to the inventory associated with the premises; and iii) the RFID-tagged asset lacks an asset-associated entry in the authorization database associated with the premises; and access video footage from the video server based on the AEII, or the unique identifier for the RFID-tagged asset, or both.

In an example embodiment, the processor and the memory cooperate to receive information from the access point to generate a transaction report including transaction report data, and wherein creating the asset-based event-of-interest identifier comprises accessing the transaction report data to determine when the RFID-tagged asset is detected by the access point.

In an example embodiment, the unique identifier for the RFID-tagged asset comprises an electronic product code (EPC), the transaction report data comprises the EPC, and the video footage is accessed from the video server based on the EPC.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described.

Embodiments of the present disclosure provide a video management device or system that integrates four aspects of RFID, video, authorization (such as POS) and inventory. Embodiments of the present disclosure provide a method for managing an asset, such as an inventory item, by using RFID.

Typically, RFID is used for inventory tracking, such as to ensure inventory accuracy. In some cases, RFID can be used as a replacement for magnetic tags used in retail security systems. Embodiments of the present disclosure use RFID detection and tracking in a different way than it was intended, by advantageously integrating RFID detection with video surveillance data, authorization data (such as point-of-sale transaction data), and inventory data. This goes beyond presence-based RFID systems to provide intelligent inventory or asset management.

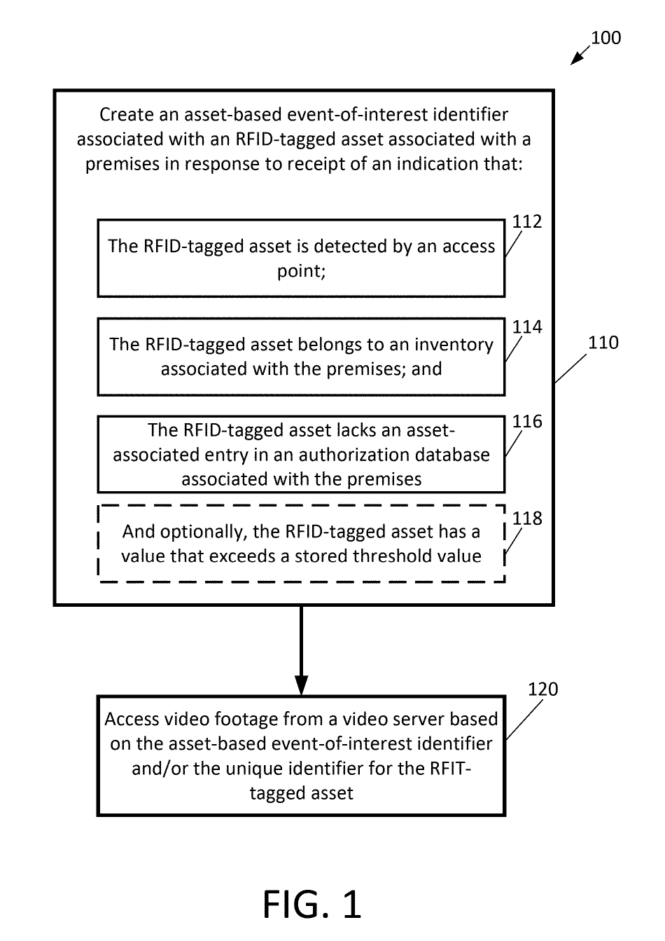

FIG. 1 is a flowchart illustrating a method according to an embodiment of the present disclosure. A method 100 is illustrated of obtaining video associated with a loss prevention event-of-interest. The method comprises, at 110, creating an asset-based event-of-interest identifier (AEII) associated with an RFID-tagged asset associated with a premises. The act 110 is performed in response to receipt of an indication that: the RFID-tagged asset is detected by an access point (112); the RFID-tagged asset belongs to inventory associated with the premises (114); and the RFID-tagged asset lacks an asset-associated entry in an authorization database associated with the premises (116). The method further comprises, at 120, accessing video footage from a video server based on the asset-based event-of-interest identifier and/or the unique identifier for the RFID-tagged asset.

It is worth noting that the method is performed for the purposes of loss prevention and litigation management, and is not meant to replace a magnetic tag-based security system that generates an audible or visual alarm, or both, when a person attempts to leave a premises with a tagged item. In fact, the method according to an embodiment of the present disclosure can be provided as a complement to such a static tag-based security system. A tag-based security system can typically only generate an alert when an item is crossing a threshold. In contrast, a method of an embodiment of the present disclosure provides a direct link between an RFID-tagged asset, the fact that the RFID-tagged asset belongs to an inventory of the premises and was not authorized to leave the premises, and accesses video footage that can be used for loss prevention or litigation management.

For example, the accessed video can show a particular person leaving a premises at the exact same time that an event-of-interest identifier was generated relating to an RFID-tagged asset. This video evidence can be used to show, for example, a correlation or correspondence between the movement of the person and the detected movement of the specific RFID-tagged asset, that person is stealing items that were not purchased, or removing them without authorization; such identification is not possible using known approaches and their associated limitations.

In an example embodiment, the accessing in 120 occurs after the event-of-interest has occurred. In such a case, the video footage comprises stored video footage accessed from a video archive or other video storage. In another example embodiment, accessing the video footage comprises accessing live video footage from a video server.

In an example embodiment, detection by the access point in 112 comprises detecting that the RFID-tagged item is exiting the premises. This example embodiment can be employed in a retail or other commercial setting. In another example embodiment, detection by the access point in 112 comprises detecting that the RFID-tagged item is crossing a threshold, or leaving the field of view of a camera. This example embodiment is beneficial in situations where it is important to know if an asset-of-interest is either entering or exiting a specific location of interest, which may or may not be on the premises or associated with the premises. In a further example embodiment, detection by the access point in 112 comprises detecting that the RFID-tagged item is leaving a field of view of a camera associated with the premises.

In the embodiment of FIG. 1, the act 116 is performed in relation to an authorization database, for example to determine if the RFID-tagged asset was authorized to leave the premises or otherwise be detected by an access point. In an example embodiment, the authorization database includes an indication of one or more physical areas in which the RFID-tagged asset is authorized to be detected. If an area associated with an access point, such as a field of view of a camera, does not match one of the physical areas in which the RFID-tagged asset is authorized to be detected, then the RFID-tagged asset is determined to lack an asset-associated entry in the authorization database associated with the premises.

In another example embodiment, the authorization database comprises a point-of-sale (POS) transaction database. In such an embodiment, the AEII is created in response to: the RFID-tagged asset being detected by an access point; the RFID-tagged asset belonging to an inventory associated with the premises; and in response to the RFID-tagged asset lacking an asset-associated entry in the POS transaction database associated with the premises. For example, if the RFID-tagged asset comprises an RFID-tagged item for sale, then the AEII is created when the item belongs to the inventory associated with the premises, and there is no record in the POS transaction database associated with the item, and the item is detected by an access point, such as exiting the premises.

In an example embodiment, the AEII is created, and video is accessed, only when the tagged asset is confirmed to be part of an associated inventory, and there is no corresponding purchase transaction; this means that the item was in inventory but was not purchased, and should be investigated with respect to loss prevention, as it was likely stolen. After the AEII is created, the corresponding video surveillance footage can immediately be accessed based on the association with the item identifier and/or the point-of-sale transaction data.

In some implementations, a large inventory of items or a high volume of purchase transactions or other authorization events can make it desirable to selectively create the AEII, for example based on one or more criteria. For example, suppose only RFID-tagged assets or items of a certain minimum value are of interest. In an example embodiment, step 110 of creating the AEII is selectively performed when the RFID-tagged asset or item has a value that exceeds a stored threshold value.

In an example embodiment, as shown in FIG. 1, this can be achieved in optional step 118 which represents an optional fourth condition that is met before creating the AEII. In this case, in addition to the criteria in 112, 114, and 116, the AEII is created in response to an indication that the RFID-tagged asset has a value that exceeds a stored threshold value. The stored threshold value can be set depending on the implementation. For example, the stored threshold value may be set to a lower value at a clothing store than it is at a jewelry store. In another example embodiment, the method further comprises: comparing a value associated with the RFID-tagged asset with a stored threshold value; and performing step 110 only when the value of the RFID-tagged asset exceeds the stored threshold value.

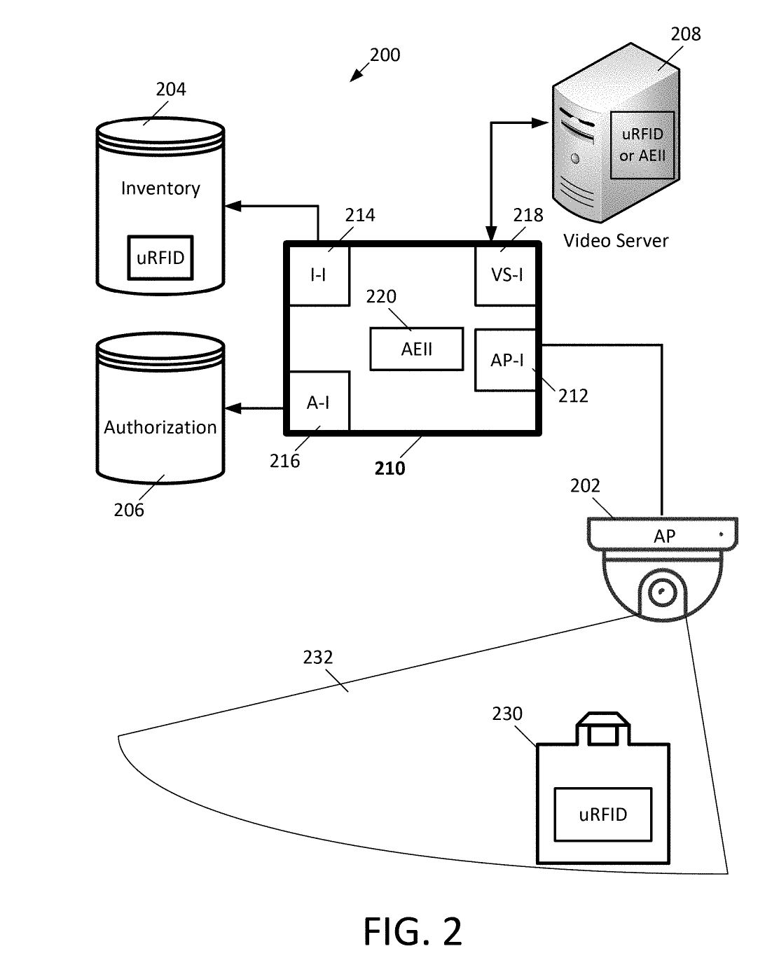

In some implementations, a method according to an embodiment of the present disclosure is performed in the context of a system comprising a video management device (such as shown as element 210 in FIG. 2, described later). A video management device can provide business intelligence based on analysis of video data. A video management device can include functionality to provide different reports, such as a transaction report.

In an example embodiment, creating the asset-based event-of-interest identifier comprises accessing data from a transaction report to determine when the RFID-tagged asset is detected by the access point. Such a transaction report can be produced by, or received from, the video management device. In an example implementation, the data from the transaction report can identify a timeframe associated with the detection by the access point. The data on the transaction report can also include one or more of: a company prefix; an item identifier, such as the unique identifier; and the actual product serial number. For example, one code can identify the manufacturer as a particular company, and another code can identify the asset as a particular item, such as a wide-screen television. In an example embodiment, the data in the report comprises an electronic product code (EPC), which is the electronic equivalent of the UPC (Universal Product Code). In an example embodiment, the unique identifier for the RFID-tagged asset comprises an electronic product code (EPC).

In addition to obtaining video associated with a loss prevention event-of-interest, embodiments of the present disclosure can leverage data used in such process to provide additional advantages, including identifying unauthorized movement or dwell time.

In an example embodiment, the method further comprises identifying unauthorized movement of the RFID-tagged asset based on the asset-based event-of-interest identifier and on the video footage accessed from the video server. Identifying unauthorized movement can be an important trigger associated with a loss prevention event-of-interest.

In another example embodiment, the method further comprises identifying a dwell time for the RFID-tagged asset based on the asset-based event-of-interest identifier and on the video footage accessed from the video server. Identifying dwell time can be important for loitering detection, as loitering is often associated with a planned theft. As such, identifying a dwell time that exceeds a stored threshold dwell time value can be used as a trigger to deter a planned theft.

In an example embodiment, the present disclosure provides a non-transitory machine readable medium having stored thereon statements and instructions for execution by a processor to perform a method as both generally and specifically described and illustrated herein.

In another example embodiment, the present disclosure provides a system, such as a video surveillance loss prevention system, comprising: a processor; and a memory storing statements and instructions for execution by the processor to perform a method of obtaining video associated with a loss prevention event-of-interest. The method comprises: creating an asset-based event-of-interest identifier associated with an RFID-tagged asset associated with a premises in response to receipt of an indication that: the RFID-tagged asset is detected by an access point; the RFID-tagged asset belongs to inventory associated with the premises; and the RFID-tagged asset lacks an asset-associated entry in an authorization database associated with the premises. The method also comprises accessing video footage from a video server based on the asset-based event-of-interest identifier and/or the unique identifier for the RFID-tagged asset.

FIG. 2 illustrates a system according to an embodiment of the present disclosure. The system, such as a video surveillance loss prevention system, 200, comprises a video management device 210. The video management device 210 is in communication with an access point 202, such as via an access point interface 212. The video management device 210 is also in communication with an inventory database 204, such as via an inventory interface 214. The video management device 210 is also in communication with an authorization database 206, such as via an authorization database interface 216. Finally, the video management device 210 is in communication with a video server 208, such as via a video server interface 218.

The video management device 210 is configured to create an asset-based event-of-interest identifier (AEII) associated with an RFID-tagged asset 230 associated with a premises. In an example embodiment, the RFID-tagged asset 230 comprises a unique identifier, such as a unique RFID identifier. In an example embodiment, the RFID-tagged asset is within a field of view 232 of the access point 202. In an embodiment, the video management device 210 creates the AEII in response to receipt of an indication that: i) the RFID-tagged asset is detected by the access point 202; ii) the RFID-tagged asset belongs to the inventory 204 associated with the premises; and iii) the RFID-tagged asset lacks an asset-associated entry in the authorization database 206 associated with the premises. The video management device 210 also accesses video footage from the video server 208 based on the AEII, or the unique identifier for the RFID-tagged asset 230, or both.

In an example embodiment, any time an RFID-tagged asset is detected by an access point, and the other conditions for creating an AEII are met, the information is pushed up to the video management device 210 as an event. Consequently, the video management device enables a user to search for a particular RFID item, see the logs for the last times it was seen, or even every time it was seen, and immediately bring up the video and see what happened.

For example, if big screen TVs are going back and forth between locations, the video management device 210 according to an embodiment of the present disclosure enables a user to see the last time one of the TVs exited the facilities or premises, and provides immediate access to video showing what happened. In an HVAC environment, where some equipment is worth $10-15 k, the equipment often goes missing and RFID tagging in this way would be beneficial, particularly when tied to an identification of whether the item belongs to inventory. In such a case the inventory comprises an inventory of equipment belonging to a facility, rather than an inventory of items for sale or purchase.

In an example embodiment, the video management device is configured to produce a report to reduce loss prevention. For example, for a company that has 1,000 locations, the video management device can produce a report of every time an RFID-tagged asset that belonged to their inventory exited one of their locations without a POS transaction. Such a report may very well identify a list of all of the items that were stolen, with immediate access to the video associated with the event when it happened.

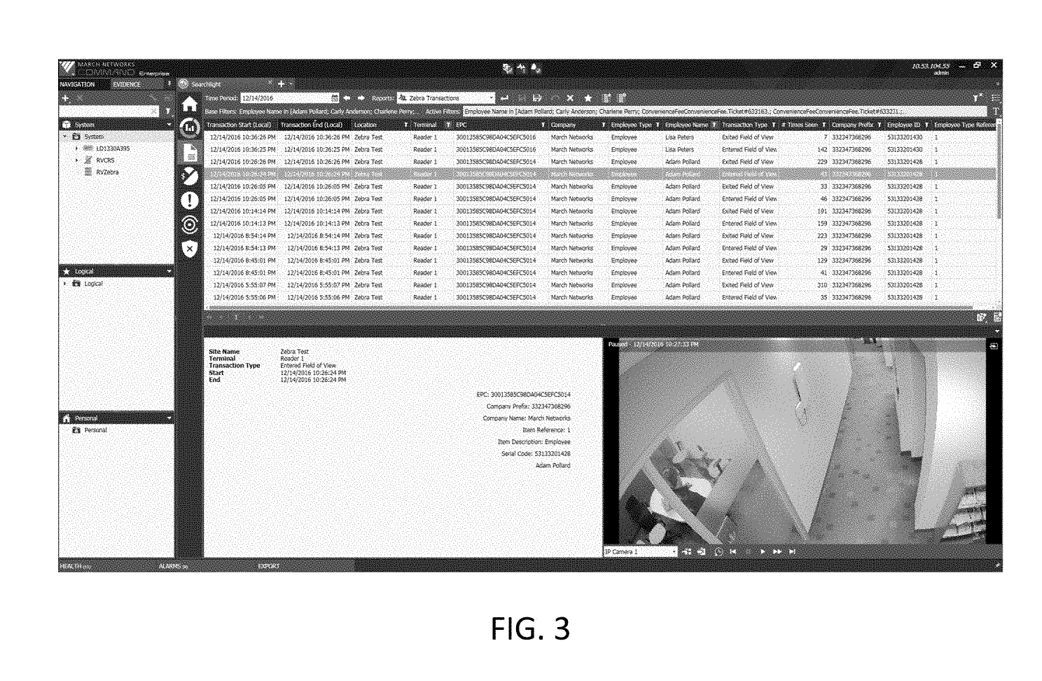

FIG. 3 illustrates a screenshot of a report, such as a transaction report, produced by a video management device according to an embodiment of the present disclosure. In an example implementation, the transaction report comprises data that can identify a timeframe associated with the detection by the access point. In another example implementation, the transaction report data includes one or more of: a company prefix; an item identifier, such as the unique identifier; and the actual product serial number. For example, one code can identify the manufacturer as a particular company, and another code can identify the asset as a particular item, such as a wide-screen television. In an example embodiment, the data in the report comprises an electronic product code (EPC), which is the electronic equivalent of the UPC (Universal Product Code), and can be the unique identifier for the RFID-tagged asset.

In an example embodiment relating to FIGS. 2 and 3, the processor and the memory cooperate to receive information from the access point and to generate a transaction report including transaction report data. In that case, creating the asset-based event-of-interest identifier comprises accessing the transaction report data to determine when the RFID-tagged asset is detected by the access point. In an example embodiment, the unique identifier for the RFID-tagged asset comprises an EPC, the transaction report data comprises the EPC, and the video footage is accessed from the video server based on the EPC.

In an example embodiment, system and associated method are not limited to inventory management, and can be used to access video in response to tracking the unauthorized departure of any asset of interest from an area of interest. For example, the method and system can be used to track equipment in an industrial environment, or to track pallets of items at different stages in a transportation chain.

In an example embodiment, instead of accessing video strictly in association with inventory management, a method and system according to an embodiment of the present disclosure can be used more broadly to access video in association with asset management. In a scenario in which high value items (e.g. iPads or computers) are tagged to make sure they do not go missing, the video can be accessed in response to selective generation of the AEII when the item is identified as being a high value item. In a further example embodiment, the method and system are applied through an entire logistics cycle, to enable accessing video in response to creation of an asset-based event-of-interest identifier associated with an RFID-tagged asset. For example, RFID can be used in the production of plant products, such as marijuana, because in a regulated industry producers have to track from when they start growing it to when they sell it, and the whole product has to be integrated. So, even the product on the store shelves has RFID associated with it. The seeds, plants, and larger packages can all be assets that are RFID-tagged, as well as smaller packages. The video can be accessed in response to creation of the AEII when the asset is one or more of the items in the logistics cycle, where inventory management is broader than just retail and what is on the shelf. Other examples include creating an AEII when the asset is an oil barrel being tracked, and video relating to the tracked oil barrel is accessed in response to creation of the AEII. In a transportation logistics implementation, RFID tags can be used in conjunction with cameras on docks so that a logistics company can identify when specific pallets have gone into trucks, where the pallets and the truck are both examples of RFID-tagged assets. This is possible with existing RFID tags (antennas with 30-40 feet). To increase range/detectability, a powered/active RFID tag can be provided, such as in a pallet; or in a really big bay door. An access point can be provided having a plurality of ports, and the item can be tagged with a corresponding plurality of RFID tags or antennas. The video can be accessed in response to creation of the AEII when the RFID-tagged asset is one or more of the items in the transportation logistics implementation.

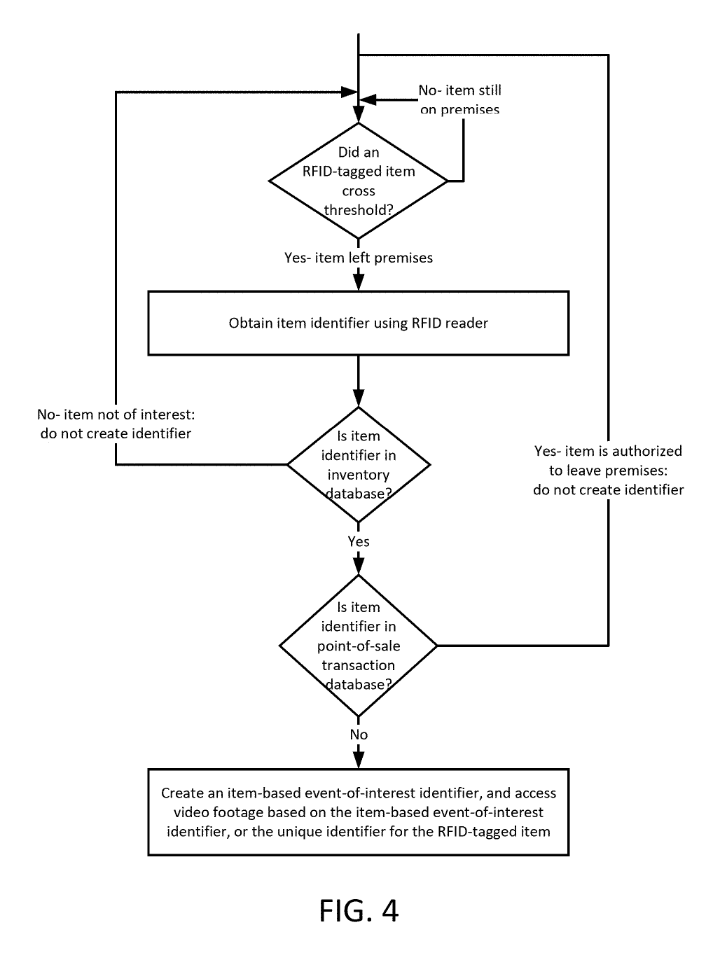

FIG. 4 is a flowchart illustrating a method according to an example embodiment of the present disclosure. FIG. 4 represents a decision-based flowchart corresponding to the flowchart of FIG. 1, for an example embodiment in which: the asset is an item; detection by the access point comprises crossing a threshold; and the authorization database is a point-of-sale transaction database. The decision boxes in FIG. 4 provide a visual representation of the three conditions in this example embodiment for creating the AEII and accessing the video footage based on the AEI or the unique identifier for the RFID-tagged item, or both.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A method of obtaining video associated with a loss prevention event-of-interest, comprising:
a) creating an asset-based event-of-interest identifier associated with an RFID-tagged asset associated with a premises in response to receipt of an indication that:
i) the RFID-tagged asset is detected by an access point;
ii) the RFID-tagged asset belongs to inventory associated with the premises; and
iii) the RFID-tagged asset lacks an asset-associated entry in an authorization database associated with the premises; and
b) accessing video footage from a video server based on the asset-based event-of-interest identifier, or based on the unique identifier for the RFID-tagged asset, or both.

2. The method of claim 1 wherein the accessing occurs after the event-of-interest has occurred, and wherein the video footage comprises stored video footage accessed from a video archive or other video storage.

3. The method of claim 1 wherein accessing the video footage comprises accessing live video footage from a video server.

4. The method of claim 1 wherein detection by the access point comprises detecting that the RFID-tagged item is exiting the premises.

5. The method of claim 1 wherein detection by the access point comprises detecting that the RFID-tagged item is crossing a threshold.

6. The method of claim 1 wherein detection by the access point comprises detecting that the RFID-tagged item is leaving a field of view of a camera associated with the premises.

7. The method of claim 1 wherein the authorization database comprises a point-of-sale (POS) transaction database.

8. The method of claim 1 wherein the RFID-tagged asset comprises an RFID-tagged item for sale.

9. The method of claim 1 wherein creating the AEII is performed in response to receipt of indications i), ii), and iii), and also in response to an indication that:
iv) the RFID-tagged asset has a value that exceeds a stored threshold value.

10. The method of claim 1 further comprising:
comparing a value of the RFID-tagged asset with a stored threshold value; and
performing step a) only when the value of the RFID-tagged asset exceeds the stored threshold value.

11. The method of claim 1 wherein creating the asset-based event-of-interest identifier comprises accessing data from a transaction report to determine when the RFID-tagged asset is detected by the access point.

12. The method of claim 11 wherein the data from the transaction report identifies a timeframe associated with the detection by the access point.

13. The method of claim 1 further comprising identifying unauthorized movement of the RFID-tagged asset based on the asset-based event-of-interest identifier and on the video footage accessed from the video server.

14. The method of claim 1 further comprising identifying a dwell time for the RFID-tagged asset based on the asset-based event-of-interest identifier and on the video footage accessed from the video server.

15. The method of claim 1 wherein the unique identifier for the RFID-tagged asset comprises an electronic product code (EPC), and the video footage is accessed from the video server based on the EPC.

16. A non-transitory machine readable medium having stored thereon statements and instructions for execution by a processor to perform the method of claim 1.

17. A system comprising:
a processor; and
a memory storing statements and instructions for execution by the processor to perform a method of obtaining video associated with a loss prevention event-of-interest, the method comprising:
a) creating an asset-based event-of-interest identifier associated with an RFID-tagged asset associated with a premises in response to receipt of an indication that:
iv) the RFID-tagged asset is detected by an access point;
v) the RFID-tagged asset belongs to inventory associated with the premises; and
vi) the RFID-tagged asset lacks an asset-associated entry in an authorization database associated with the premises; and
b) accessing video footage from a video server based on the asset-based event-of-interest identifier, or based on the unique identifier for the RFID-tagged asset, or both.

18. A video management device for use in a video surveillance loss prevention system, the video management device comprising:
an access point interface configured to enable communication between the video management device and an access point;
an inventory interface configured to enable communication between the video management device and an inventory database;
an authorization interface configured to enable communication between the video management device and an authorization database;
a video interface configured to enable communication between the video management device and a video server;
a processor; and
a memory storing statements and instructions for execution by the processor to:
create an asset-based event-of-interest identifier (AEII) associated with an RFID-tagged asset associated with a premises in response to receipt of an indication that: i) the RFID-tagged asset is detected by the access point; ii) the RFID-tagged asset belongs to the inventory associated with the premises; and iii) the RFID-tagged asset lacks an asset-associated entry in the authorization database associated with the premises; and
access video footage from the video server based on the AEII, or the unique identifier for the RFID-tagged asset, or both.

19. The video management device of 18 wherein the processor and the memory cooperate to receive information from the access point to generate a transaction report including transaction report data, and wherein creating the asset-based event-of-interest identifier comprises accessing the transaction report data to determine when the RFID-tagged asset is detected by the access point.

20. The video management device of 18 wherein the unique identifier for the RFID-tagged asset comprises an electronic product code (EPC), the transaction report data comprises the EPC, and the video footage is accessed from the video server based on the EPC.
